(19) United States
(12) Patent Application Publication
(10) Pub. No.: US 2007/0072142 A1
(43) Pub. Date: Mar. 29, 2007

(54) Apparatus for dislodging an intraoral device

(76) Inventors: William Franklin Staines, Carmichael, CA (US); Trevor Lance Ragan, Yreka, CA (US)

Correspondence Address: W. Eric Boyd, Esq., 39 Albergar, San Clemente, CA, 92672, US

(21) Appl. No.: 11/236,813

(22) Filed: Sep. 28, 2005

(51) Int. Cl. A61C 3/00

(52) U.S. Cl. 433/3; 433/141

(57) ABSTRACT

An apparatus to assist in the dislodging of an intraoral device. The apparatus comprises an elongate body having a central portion, a first distal portion having a first terminal end and an opposing second distal portion having a second terminal end. The first terminal end further comprises an outwardly depending lip and the second terminal end comprises an arcuate projection. The lip is used to exert a mechanical force on an affixed intraoral device to assist in dislodging the device. The arcuate projection is inserted in between the intraoral device and the tooth to assist in dislodging the device.

### BACKGROUND OF THE INVENTION

1. Field of the Invention

The invention generally relates to dentistry and intraoral dental devices. Specifically, the invention relates to an apparatus used to dislodge or remove an intraoral device such as an orthodontic aligner from a user's mouth.

2. Description of the Prior Art

The dental and orthodontic arts use a variety of intraoral devices that are removably affixed to a patient's dentition. One application of such a device is the progressive orthodontic alignment of one or more teeth in a patient's mouth. A well-known example of a progressive alignment system is that offered by Align Technology, Inc. under the Invisalign trademark which uses a series of preformed dental appliances to progressively reposition one or more teeth in a patient's mouth.

Other applications of intraoral devices include protecting teeth from damage due to bruxisim or “tooth grinding” using a removable plastic appliance that mounts on the upper or lower teeth, maintaining alignment of teeth using a retainer or prosthetic devices such as dentures or bridges. A common attribute of these devices is that they are intended to be temporarily positioned in a patient's mouth and are selectively removable by the patient such as when eating, flossing, brushing, sleeping or waking.

These intraoral devices are typically fabricated from impressions taken of a patient's dentition, which are then used as molds to form custom devices from a variety of elastomers such as silicone rubbers and elastomers, LTV vinyl silicone or polypropylene.

Once fabricated, the above intraoral devices are fitted in the patient's mouth using a friction or compression fit. Such devices rely on a compression, tension or combination of compression and tension on one or more tooth surfaces to stay affixed in the patient's mouth. Depending on the application, the fit of such devices is intended to be snug fitting on the tooth structures which can result in significant effort by a patient to remove the device. Elderly or disabled individuals, individuals with arthritis or individuals with artificial or longer fingernails may encounter particular difficulty in removing such devices or may even be physically unable to remove a device.

Heretofore, no apparatus has been available to users of fitted intraoral devices to assist in their dislodging or removal from the patient's mouth.

What is needed is an apparatus that will allow the convenient dislodging and removal of a fitted intraoral device that is both inexpensive to fabricate and easy to use.

### BRIEF SUMMARY OF THE INVENTION

The illustrated embodiments of the invention disclose an apparatus to assist in the dislodging of an intraoral device fitted in a person's mouth. In a preferred embodiment, an elongate body is provided comprising a central portion, a first distal portion having a first terminal end and an opposing second distal portion having a second terminal end.

The first terminal end further comprises an outwardly depending lip and the second terminal end comprises an arcuate projection.

Alternative embodiments may comprise, without limitation, an angled or offset central portion and a stiffening structure provided along the length of the central portion.

While the above apparatus has or will be described for the sake of grammatical fluidity with functional explanations, it is to be expressly understood that the dental apparatus claims, unless expressly formulated under 35 USC 112, are not to be construed as necessarily limited in any way by the construction of “means” or “steps” limitations, but are to be accorded the full scope of the meaning and equivalents of the definition provided by those claims under the judicial doctrine of equivalents, and in the case where the claims are expressly formulated under 35 USC 112 are to be accorded full statutory equivalents under 35 USC 112.

### BRIEF DESCRIPTION OF THE DRAWINGS

FIG. 1 is a plan view of a preferred embodiment of the present invention.

FIG. 2 is a side view of a preferred embodiment of the present invention.

FIG. 3 is a cross-section taken along X-X of FIG. 1 of the present invention.

FIG. 4 is an enlarged view of Detail 1 of FIG. 2.

FIG. 5 is alternative preferred embodiment of the present invention showing the first terminal end thereof angularly disposed to the body at an angle of about 8 degrees.

FIG. 6 is alternative preferred embodiment of the present invention showing the first terminal end thereof angularly disposed to the body at an angle of about 10 degrees.

FIG. 7 is alternative preferred embodiment of the present invention showing the first terminal end thereof angularly disposed to the body at an angle of about 15 degrees.

FIG. 8 illustrates the use of first distal portion of the invention to dislodge an intraoral device from a user's teeth.

FIG. 9 illustrates the use of second distal portion of the invention to dislodge an intraoral device from a user's teeth.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

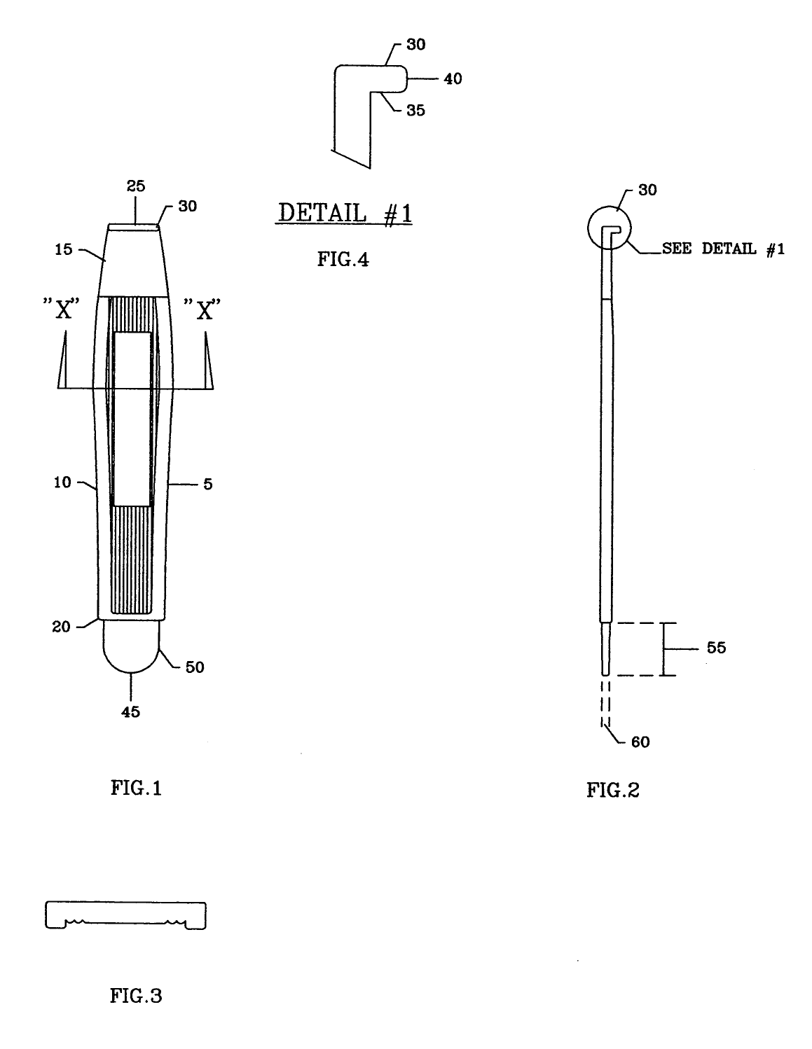

Turning now to the figures wherein like numerals designate like elements among the several views, FIGS. 1 and 2 illustrate a preferred embodiment of the apparatus of the present invention.

The apparatus of the invention comprises an elongate body 5 preferably manufactured from a suitable, non-toxic plastic or elastomeric material, capable of being sanitized for use in a person's mouth. Body 5 is preferably fabricated from a material of a sufficient rigidity to allow the apparatus to transfer the mechanical forces generated by the user to the distal portions of the apparatus and ultimately to the intraoral device that is being dislodged. Alternatively, a stiffening member may be providing along the length of body 5 to provide the desired rigidity.

Body 5 is comprised a central portion 10 of sufficient length and width such that it can be manipulated by a person's fingers. By way of example and not by limitation, central portion has a nominal width of about 0.75 inches and a length of about 3 inches and may be provided with a taper along its length extending inwardly from the center thereof.

FIG. 3 illustrates an exemplar cross-section of the invention showing the thickness of central portion 10. The thickness of central portion 10 preferably ranges from 0.095 to 0.125 inches. Width, thickness and length may be varied during design and manufacturing, dependent upon the intended end user's needs, i.e., smaller for children's use, wider for individuals with difficulty manipulating articles with their fingers or hands.

Body 5 is further comprised of a first distal portion 15 and a second distal portion 20.

As can be readily seen in FIG. 4, first distal portion 15 is comprised of a first terminal end 25 having an outwardly depending lip 30. Lip 30 comprises a lip height 35, preferably about 0.10 inches in height and a lip thickness 40.

Second distal portion 20 comprises a second terminal end 45 having an arcuate projection 50 extending longitudinally therefrom, preferably of about a 0.375 inch radius. Projection 50 comprises a projection length 55 and a projection thickness 60. Projection length 55 is preferably about 0.50 inches and projection thickness is preferably about 0.0625 inches.

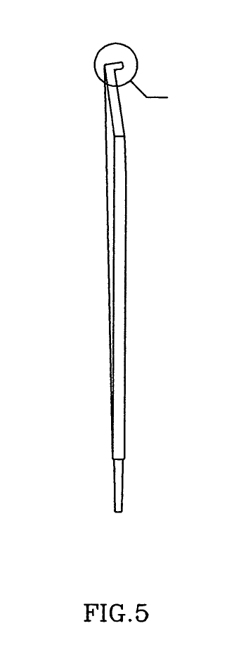

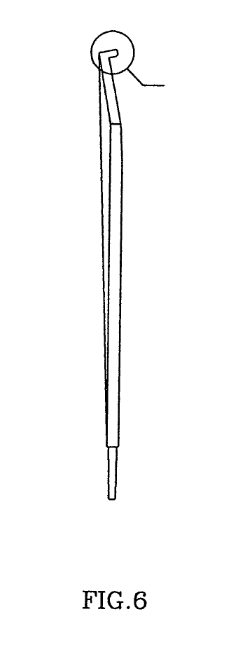

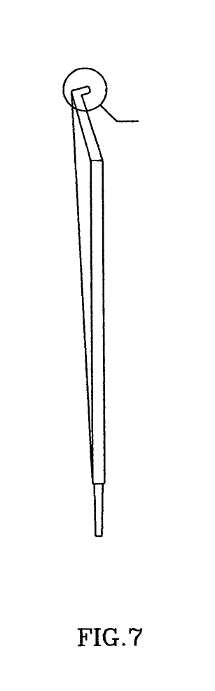

In an alternative preferred embodiment, central portion 10 further comprises an angle whereby first distal portion 15 is angularly disposed with respect to second distal portion 20. Exemplar alternative embodiments are shown in FIGS. 5, 6 and 7, showing central portion 10 comprising an angle of 8 degrees, 10 degrees and 15 degrees, respectively. It is to be specifically noted that the angle may be greater or smaller than these illustrated embodiments.

The apparatus of the present invention is simple to use. In its preferred application, the user may selectively use the elements of the first distal portion or second distal portion, depending on the user's preference and on the characteristics of the fit of the intraoral device.

When using first distal portion 15, lip 30 is oriented such that it is positioned along the upper or lower periphery of an intraoral device which typically along the user's gum line. The user can selectively orient lip 30 on the lingual or buccal aspects of the maxillary or mandibular teeth, typically along the anterior teeth. The user exerts a vector force approximately normal to and upwardly (for mandibular teeth) or downwardly (for maxillary teeth) from the gum line whereby the intraoral device is urged off of the tooth surfaces.

When using second distal portion 20, arcuate projection 50 is inserted by the user in between the intraoral device and the teeth to allow the user to urge the intraoral device upwardly or downwardly away from the teeth.

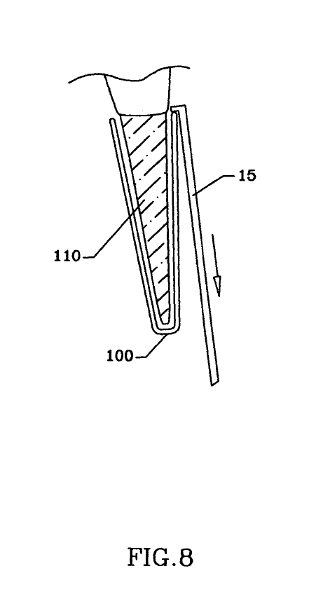

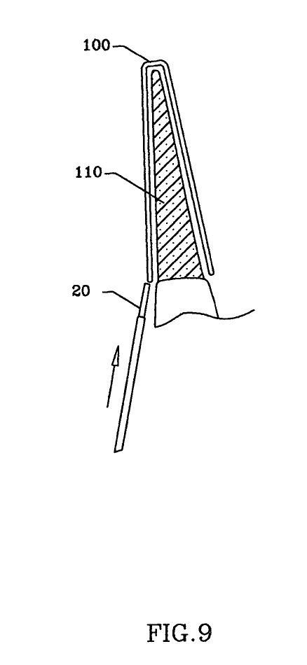

By way of example and not by limitation, use of first and second distal portions to dislodge an intraoral device 100 from teeth 10 are shown in FIGS. 8 and 9 respectively.

Many alterations and modifications may be made by those having ordinary skill in the art without departing from the spirit and scope of the disclosed invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. An apparatus for dislodging an intraoral device comprising:
an elongate body comprising a central portion and a first distal portion having a first terminal end and an opposing second distal portion having a second terminal end,
said first terminal end further comprising an outwardly depending lip having a lip height and a lip thickness,
said second terminal end further comprising a substantially arcuate projection having a projection length and a projection thickness.

2. The device of claim 1 wherein said central portion further comprises an angle whereby said first distal portion is angularly disposed to said second distal portion.

3. The device of claim 1 wherein said lip height is about 0.10 inches.

4. The device of claim 1 wherein said projection thickness is about 0.0625 inches.

5. The device of claim 1 wherein said arcuate projection has a radius of about 0.375 inches.

6. The device of claim 2 wherein said first distal portion is angularly disposed at an angle of about eight degrees relative to said second distal portion.

7. The device of claim 2 wherein said first distal portion is angularly disposed at an angle of about ten degrees relative to said second distal portion.

8. The device of claim 2 wherein said first distal portion is angularly disposed at an angle of about fifteen degrees relative to said second distal portion.

9. The device of claim 2 wherein said first distal portion is angularly disposed at an angle of more than 15 degrees relative to said second distal portion.

10. An apparatus for dislodging an intraoral device comprising:
an elongate body comprising a central portion and a first distal portion having a first terminal end and an opposing second distal portion having a second terminal end,
said first terminal end further comprising an outwardly depending lip having a lip height and a lip thickness.

11. An apparatus for dislodging an intraoral device comprising:
an elongate body comprising a central portion and a first distal portion having a first terminal end and an opposing second distal portion having a second terminal end,
said second terminal end further comprising a substantially arcuate projection having a projection length and a projection thickness.
